(19) United States
(12) Patent Application Publication
(10) Pub. No.: US 2008/0075915 A1
(43) Pub. Date: Mar. 27, 2008

(54) Composite Pad of Fiber and Foam and Related Process

(75) Inventors: Scott Wening, Camarillo, CA (US); Donald E. Tucker, Ventura, CA (US); Chris Meehan, Bell Canyon, CA (US)

Correspondence Address: SoCAL IP LAW GROUP LLP, 310 N. WESTLAKE BLVD. STE 120, WESTLAKE VILLAGE, CA, 91362, US

(73) Assignee: EnvironX, Oxnard, CA (US)

(21) Appl. No.: 11/779,793

(22) Filed: Jul. 18, 2007

Related U.S. Application Data
(60) Provisional application No. 60/826,504, filed on Sep. 21, 2006.

(51) Int. Cl. B32B 3/02; B29C 43/02; B32B 3/26

(52) U.S. Cl. 428/95; 264/319; 428/304.4; 442/1

(57) ABSTRACT

A composite pad of fiber and foam is disclosed. Processes for manufacturing such a pad are also disclosed.

### RELATED APPLICATION INFORMATION

This patent claims priority from Application No. 60/826,504 filed Sep. 21, 2006 which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to composite resilient pads, including carpet cushion pads.

2. Description of Related Art

Carpet segments that are discarded are predominantly sent to landfills, with millions of tons of discarded carpet sent to landfills each year. This poses a significant waste disposal problem, since every million pounds of discarded carpet covers approximately one acre of land almost two feet deep. The matter is more complicated, since these carpet segments are not expected to biodegrade for thousand of years, and although the carpet segments are not typically biodegradable, discarded post-consumer carpet that gets wet becomes an incubator for mold, mildew, and other noxious microbes that emit foul odors and leachates, which attract insects, which in turn attract vermin, birds, and other animals, and have consequent health impacts.

A number of efforts have been made to organize and run carpet recycling operations, but most companies that have attempted to undertake this challenge have gone bankrupt, or were shut down by a parent company after losing millions of dollars. One recent example was the decision by the Honeywell Company to halt operation of its “Evergreen” recycling operation in 2001, at a loss which has been estimated by industry observers at roughly $100,000,000.

The undesirability of continuing to send substantially large loads of discarded carpet to landfills has been recognized. The need for better alternatives has also been recognized.

The most widespread and most common use that has emerged to date, for reusing synthetic fibers obtained from discarded carpets, involves products that are known as needle-punched mats, in which, generally, a needle-punching machine, comprising barbed needles, punches the needles through a layer of long fibers (one and one half to three inches), grabbing certain fibers and stringing them through other fibers. The needle punching machine may comprise hundreds of these needles, cycling up and down rapidly, taking numerous horizontal strands, and making them more vertical. This action creates a bond, and, thus, the dimensional stability that holds the padding together.

The needle punching process, however, cannot function exclusively with post-consumer carpeting. Even post consumer carpet, at its cleanest, still contains small nodules of calcium carbonate left over from latex used to bind the backings of fiber. Such small nodules will break or bend the needles. Consequently, paddings manufactured from a needle punching process does not contain one hundred percent post-consumer carpet. In the least, the post-consumer carpet is blended with a predominate amount of post-industrial fiber to create the padding.

Needle-punched mats, resembling extra-thick and heavy woolen blankets, have two primary uses. First, they are installed in vehicles, such as for sound deadening and insulation. And second, they are installed as cushioning layers beneath carpets in locations with high levels of traffic, such as in large retail stores, and in offices.

A known problem with needle-punched mats is that they do not support a new carpet with the type of resilient, springy feel that consumers desire in carpets for the home. In comparison to foam pads, needle-punched mats are heavy, flat, limp, and “dead”. Shoppers in the United States entering major discount chains that sell carpet padding typically do not even see needle-punched mats. Such stores do not even offer needle-punched mats because they know shoppers who feel them will rarely, if ever, choose them for their homes. Instead, consumers buy carpet pads that are made from types of foam rubber shredded and bonded together (rebond), which provide the type of resilient and springiness that consumers want, expect, and find more comfortable for carpets for the homes.

Because the large majority of carpets (based on total area installed, and on number of installations) are installed in homes, rather than in stores or offices, there is only a small and limited niche demand for needle-punched mats.

There are several known problems with carpet paddings made from foam rubber. First, they wear out and wear down. Depending on the quality and density of the foam pad that is installed and the amount of foot traffic across the carpet, most types of foam pads will begin to suffer from substantial flattening and depression along the most commonly used walking routes, within a span of about one to five years. These flattened and depressed regions, along the most heavily walked pathways through a house, seriously aggravate the problem of visibly worn and unsightly “trenches” in carpets in a home. And second, they do not “breathe” in a manner that allows for moisture handling. For example, if a dog or cat urinates on a rug supported by one of these pads, the urine will tend to remain in the pad for a relatively long time, in a form that continues to emit odors.

### DESCRIPTION OF THE DRAWINGS

FIG. 1 is a perspective view of a composite pad.

### DETAILED DESCRIPTION

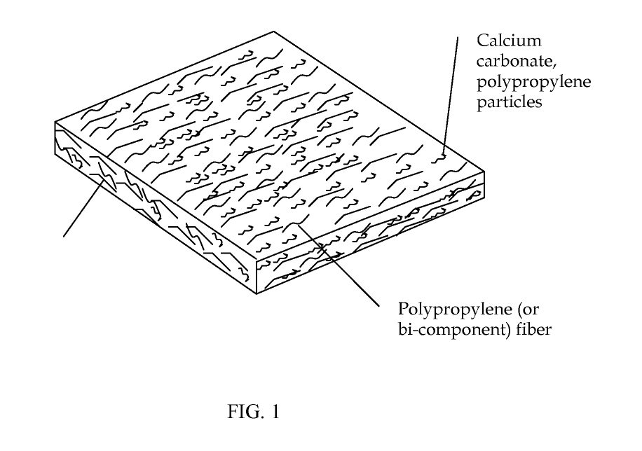

FIG. 1 shows a cushioned and bouncy composite pad using recycled materials which may be manufactured by thermobonding a mixture of shredded carpet material and pieces of foam. Carpet paddings manufactured by this process have resilience, bounciness, strength, and desirable properties for installation in homes and use by consumers, and are cost effective. A composite carpet padding is described which is able to effectively withstand moisture while maintaining springiness and resilience.

Methods of manufacturing an padding include controlling the ultimate properties of the product and provides for consistency in properties.

The disclosure includes a composite cushion structure having sixty weight percent to ninety weight percent of liberated synthetic carpet fiber comprising and thermoplastic particles from carpet backing (hardback carpets) obtained and processed from recycled post consumer carpet which are bonded together with approximately five weight percent to twenty weight percent of low-melt binder resin material having a melting point below that of the thermoplastic backing particles. The composite cushion pad can be used as carpet padding, sound proofing tiles, floor tiles, bedding and furniture padding, pads for indoor or outdoor furniture, automobile insulation and sound deadening, etc.

One type of composite pad (which can be a carpet cushion, underlayment, etc.) is formed from a thermo bond mixture of a majority of short synthetic resin fibers suitably from post consumer carpet (PCC) or post industrial carpet (PIC), and pieces of foam and a thermoplastic binder. The foam content provides this pad with a resiliency and elasticity that consumers desire for carpets in their homes, while the fibers provide reinforcement resulting in much greater levels of durability, and resistance to flattening in areas that are walked upon frequently over a span of years as in a commercial carpet padding.

This type of composite pad has a very appealing resiliency and springiness that needle-punched mats cannot match, and it provides excellent thermal insulation and noise-reduction. Further, it is largely comprised of recycled components from the PCC and PIC markets. Therefore, it can obtain vastly greater acceptability and more widespread use than needle-punched mats can obtain, in locations such as beneath carpets that are being installed in homes.

The nylon (or other synthetic) fibers are obtained from shredded carpets or textiles which are being recycled. Recycled fibers are fibers which have been used previously. Fibers which have not been used previously are considered virgin or post-industrial fibers. As such, this type of composite pad provides a highly useful and beneficial method for recycling and reusing discarded carpets that otherwise would be sent to landfills, where they would merely add to and aggravate the solid waste problems that confront landfill operators today.

These composite pads, with both fibers and foam, are manufactured by a process known as thermobonding that is substantially different from the needle-punch process that has been used to make fiber-only needle-punched mats. The mass of nylon (or other synthetic) fibers are obtained by a process including the same types of shredding and combing operations that are used in needle-punching, but that is where the similarity ends. Calcium carbonate particles and debris from the latex backing are removed. The recovered carpet fibers are then subjected to secondary grinding to mostly liberate the filaments from the twisted yarn bundles and form a filamentary gauze having fiber lengths of ¼ to 3 inches.

Using an air fiber blender, the fibers are then homogenized with particles of shredded foam. Examples of foam that have been tested and used to date have generally been open-cell urethane foams; this type of padding is widely available, and is used in both conventional light-weight foam pads made of entirely new material, and so-called “rebond” material. Rebond material is widely used for residential carpet padding, because it is tougher and more durable than light-weight pads made of a single layer foam; it contains chunks of foam that have been glued together, either by an adhesive or by a melting process, either of which leads to a network of interfaces which are stronger and more durable than the foam particles themselves.

The foam particles can be shredded to any desired size range. Some prototype composite pads that have been made to date, which were roughly ¼ to 3 inches in thickness, a size range that predominantly included but not limited to chunks of about one eighth inch up to about one half inch.

When referring to foam particles, all sizes referred to herein refer to diameters. However, that term needs attention, since particles of shredded foam will not be regular or spherical in shape. In the same way that “diameter” can mean two different things in geometry, depending on whether a sphere or a cylinder is being discussed, the same concept applies with respect to particles of shredded foam. With respect to particles that are not substantially elongated (i.e., particles which generally would be regarded as “chunks” rather than “strips”), diameter generally refers to the width of a particle across the longest or dominant axis of that particle. However, if the particle has a substantially elongated shape, in the form of a strip that would be comparable to a cylinder, the diameter is measured in a way that approximates the average thickness, rather than length, of the strip.

Because of the inherent weakness and low strength of light-weight and inexpensive open-cell foams, relatively small and cohesive chunks have been used. However, if desired, elongated strips (and blends that contain controlled mixtures of both chunks and strips) also can be tested for use as disclosed herein, to determine whether they can provide a desired balance of comfort and resilience, with strength and durability.

A similar operating parameter may also apply to the range of lengths that will be present in the fibers that will be included in the blend of foam and fibers that are included in the carpet pads disclosed herein. The prototype pads that have been manufactured to date used standard and conventional fiber preparation, which vary from one quarter inch to three inches in length that emerges from its shredding and combing machinery. However, fiber lengths and ranges may impact the quality of the pads disclosed herein. By modifying various operating parameters used in the shredding and combing machinery (which can include sorting of carpet segments into different classifications, either before or after shredding, based on whether they are “continuous pile” or “cut pile” carpets), and by using various types of chopping or slicing machines or operations, either on one or more types of carpet segments or on one or more types of shredded yarn or fiber preparations), it is possible to modify and control the lengths of the fibers that are added to the foam-and-fiber mixture. These types of operations and modifications are known to those skilled in the art, who design and/or operate the types of carpet shredding and combing machines that are used in carpet recycling operations today.

After the foam particles and shredded fibers have been blended together with low melt bonding fiber the mixture is then formed into a thick, cohesive, flattened layer by a process that is usually referred to as “bat forming”. This process generally includes the following steps:

a. the mixture of fibers and foam is deposited, in carefully controlled amounts and densities, upon a traveling conveyor system which has a supporting layer that is permeable to air, such as a metallic screen, or a loose-weave fabric that can withstand high temperatures; if desired, this conveyor system can also support a meshwork of carpet fiber or other material, which will become bonded to the pad and will become part of the pad;

b. the layer of deposited foam and fibers is flattened against the screen or fabric on the conveyor, and this may be achieved by having an upper conveyor press the material down on a lower conveyor;

c. the material then passes through an oven, which is hot enough to melt the thermobond resin, but not hot enough to melt the carpet fibers and/or foam chunks in the layered material (e.g., approximately 190-210 C. The melt point of polypropylene is about 165 C or about 320 F. The melt point for nylon6 is 220 C (428 F) and nylon66 is 265 C (500 F).

d. if desired, an adhesive material (either liquid or powdered) can also be added to the mixture at any point, and/or an additional layer of mesh or any other desired outer layer (such as a smooth film or net backing, which will allow easier sliding and adjustment of a carpet across its surface, to make an installation process easier) can also be laid on top of the foam-and-fiber mixture.

If a substantial quantity of a polyolefin material with a relatively low melting temperature is present in the foam-and-fiber mixture, then the heat-activated bonding operation can involve, and can be based upon, melting or surface-softening of the polyolefin compound. Many carpets contain backing layers made of polypropylene (a polyolefin with a melting temperature of about 325° F., which is roughly 125° less than the melting temperature of nylon). Therefore, if nylon-tufted carpets having polypropylene backing layers are shredded to provide a source of fibers, the resulting fibers will already contain a substantial quantity of polypropylene, which can be treated and utilized as a thermal bonding resin material. As required, additional quantities of polypropylene (either virgin or recycled) can be added to the foam-and-fiber mixture, and/or any other type of low-melt polyolefin or other thermobonding material can also be added, to provide higher levels of binding and adhesion (which may lead to higher levels of strength and durability) in the final pad.

If desired, the oven can include a continuous press, in which a flat-surface or flat-screen mechanical device (often called a belt) is pressed against the top of the foam-and-fiber layer, during all or part of the heating process, to increase the uniformity of the thickness of the layer that is being formed during the heating operation.

This entire operation can be carried out on a continuous conveyor system that has any desired width and density. For example, a conveyor system that is thirteen feet wide can be used to create a foam-and-fiber pad that can be side-trimmed to provide even and uniform edges, on a continuous pad that is exactly twelve feet wide. The continuous pad, after it emerges from the oven and then cools slightly, can be cut into any desired length, which can be rolled onto spools, stacked in squares, etc.

If the proper operating parameters are used, the result will be a strong and durable yet resilient and highly comfortable layer of padding. Segments of prototype pads have been manufactured, and they appear to be suitable for installing beneath a carpet.

These same materials also appear to be well-suited as bedding and furniture materials, for automotive sound deadening, and they also are likely to be adaptable to a variety of other, additional uses.

If desired, they can be coated with additional waterproof layers or other materials on either or both sides, and they can be glued, riveted, or otherwise affixed to any solid surface. It is also highly likely that methods and/or machines can be developed or adapted for sewing these thick layers to other types of fabrics.

It also should be noted that these foam-and-fiber pads may be able to handle moisture and wetness (including pet urine) better than conventional products as it allows for easier evaporation.

Improvement in uniformity and other properties may be obtained by restricting polypropylene content of the prebonded composition to below five percent and adding five to twenty percent by weight of a low melting thermoplastic resin such as nylon (polyamide), which melts at 220-250 C. A higher quality pad having better dimensional stability is formed by adding small amounts of a high melting reinforcing fiber, suitably five to twenty percent by weight. High melting in this context means a fiber having a melting point at least 100 C higher than the thermobonding resin. The thermobonding resin may be present as a sheath on the added reinforcing fiber, suitably five to fifty percent by weight of sheath to core fiber.

A commercially available bicomponent sheath-core fiber material is available as Grilon BA 3100 which is a 88 mm outer diameter fiber, five to fifty percent by weight of a polyamide 6.6 core fiber containing a polyamide 6 sheath. Both the core and the sheath are virgin polyamide fibers. The core fiber has a melting point usually at least 25 C above the melting temperature of the sheath fiber. The sheath resin uniformly melts to bond the carpet fiber, foam pieces and reinforcing fiber into a resilient pad. The carpet underlay pad may have a bicomponent sheath-core fiber material of approximately five to twenty five percent weight content in order to provide both binding and reinforcing features.

Closing Comments

The foregoing is merely illustrative and not limiting, having been presented by way of example only. Although examples have been shown and described, it will be apparent to those having ordinary skill in the art that changes, modifications, and/or alterations may be made.

Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

For means-plus-function limitations recited in the claims, the means are not intended to be limited to the means disclosed herein for performing the recited function, but are intended to cover in scope any means, known now or later developed, for performing the recited function.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. A composite cushion pad structure comprising:
60 weight percent to 90 weight percent of shredded carpet comprised of at least one of nylon, polyester and polypropylene
post consumer carpet fiber having average lengths less than 1.5 inches
10-15% of shredded foam pieces bonded together with 10 weight percent to 40 weight percent of thermal bonding resin material, having a melting point below that of the fiber material.

2. The composite cushion pad structure of claim 1, further comprising
an open scrim layer thermally bonded to the bottom surface of the cushion structure wherein the scrim layer has a melting point of lower than the melting point of the thermal bonding resin.

3. The composite cushion pad structure of claim 1 having a top surface and a bottom surface and further comprising
a scrim layer adhered to both the top and bottom surfaces.

4. The composite cushion pad structure of claim 3 further comprising
a spunbonded polyester, high porosity open fiber strand scrim layer adhered to the top or bottom surfaces of the pad, the spunbonded polyester high porosity scrim layer having a melting point of approximately 240 C plus so as to conform to and bond with the fibers on the bottom or top surfaces or planes of the pad
a polypropylene open fiber strand scrim layer adhered to the opposite bottom or top surfaces of the pad, the polypropylene scrim layers having a melting point of approximately 140 C to 150 C so as to conform to and bond with the fibers on the bottom or top surfaces or planes of the pad
the scrim layer allowing air to flow or circulate between and through the fibers of both the polypropylene scrim layers and the spunbonded polyester scrim layers to the pad fibers.

5. A composite cushion structure produced by conveying and compressing the composite cushion pad structure of claim 1 as it travels through a heat source.

6. A composite cushion pad having at least one scrim layer adhesively secured to a top or bottom layer of the pad.

7. A method for manufacturing a composite, resilient pad structure comprising:
homogeneous blending of hi-melt recovered post consumer carpet fibers, pieces of foam, and lo-melt thermal bonding resin material
conveying and compressing the formed material to size through a heat source
conveying and compressing the formed and heated material to size through a cooling device.

8. A carpet underlay comprising:
approximately 5-25 percent weight polyamide
approximately 60-90 percent weight post consumer content carpet fiber
approximately 2-25 percent weight urethane.

9. The carpet underlay of claim 8 wherein the urethane comprises chunks.

10. The carpet underlay of claim 9 wherein the urethane chunks have a diameter of approximately ⅛-½ inch.

11. The carpet underlay of claim 8 wherein the carpet fiber is shredded.

12. The carpet underlay of claim 8 wherein the polyamide includes a virgin polyamide 6 and a virgin polyamide 6/6.

13. The carpet underlay of claim 12 wherein the virgin polyamide 6/6 is a reinforcing fiber.

14. The carpet underlay of claim 13 wherein the virgin polyamide 6 is a binding agent.

15. The carpet underlay of claim 14 wherein the urethane comprises chunks having a diameter of approximately ⅛-½ inches.

16. The carpet underlay of claim 15 wherein the carpet fiber is shredded to a length of less than approximately ½ inches.

17. A process of forming a carpet pad comprising:
shredding a post consumer content carpet fiber
mixing the post consumer content carpet fiber with urethane rubber chunks and a virgin coaxial fiber, wherein
the virgin coaxial fiber includes a polyamide 6 sheath and a polyamide 6/6 core
the polyamide 6 sheath and the polyamide 6/6 core has a weight percentage ratio of one to one
the virgin coaxial fiber has a length of approximately 40-60 millimeters
heating the mixture to a temperature wherein the polyamide 6 sheath melts and the polyamide 6/6 does not melt
cooling the mixture such that the polyamide 6 is a binding agent and the polyamide 6/6 is a reinforcing fiber.

18. The process of forming a carpet pad of claim 17 wherein the post consumer content carpet fiber is shredded to a length of approximately ⅜-1½ inches.

19. The process of forming a carpet pad of claim 18 wherein the urethane chunks have a diameter of approximately ⅛-½ inches.

20. The process of forming a carpet pad of claim 19 wherein the weight percentage of post consumer content carpet fiber, urethane chunks and virgin coaxial fiber is approximately 5-25 percent, 60-90 percent and 15-25 percent, respectively.

21. The process of forming a carpet pad of claim 20 wherein the temperature is approximately 220-250 degrees Fahrenheit.

22. The process of forming a carpet pad of claim 21 wherein calcium carbonate material is filtered out of the ground post consumer content carpet fiber.
